(19) United States
(12) Patent Application Publication
(10) Pub. No.: US 2005/0049936 A1
(43) Pub. Date: Mar. 3, 2005

(54) Method of encouraging repeat ticket purchase and a ticket

(76) Inventor: Grant Langley Hohepa Shaw, Duncraig (AU)

Correspondence Address: DOUGHERTY, CLEMENTS & HOFER, 1901 ROXBOROUGH ROAD, SUITE300, CHARLOTTE, NC, 28211, US

(21) Appl. No.: 10/962,640

(22) Filed: Oct. 12, 2004

(30) Foreign Application Priority Data
Apr. 10, 2002 (AU) PS1661
Apr. 9, 2003 (WO) PCT/AU03/00420

(51) Int. Cl. G06F 17/00

(52) U.S. Cl. 705/26

(57) ABSTRACT

A method of encouraging repeat ticket purchase is disclosed. The method includes the steps of providing a plurality of purchasable tickets associated with an event, providing each of at least some of the tickets with a unique identifier, randomly selecting at least one of said tickets provided with respective unique identifiers, and offering to a ticket purchaser in possession of a randomly selected ticket an item associated with the event or an item associated with one or more participants in the event. A ticket (10) suitable for use in the method is also disclosed, the ticket (10) comprising a substrate (12) and printed matter (20, 22, 23, 24, 28, 30, 42, 44, 58) disposed on the substrate (12). The printed matter has characteristics related to at least one of the event participants.

### CROSS REFERENCE TO RELATED APPLICATION

This application claims the benefit of International Patent Application No. PCT/AU03/00420, filed on Apr. 9, 2003, further claiming priority of Australian Patent Application No. PS1661, filed on Apr. 10, 2002 pursuant to M.P.E.P. § 201.11(a).

### FIELD OF THE INVENTION

The present invention relates to a method of encouraging repeat ticket purchase and to a ticket which may be used with such a method.

### BACKGROUND OF THE INVENTION

It will be understood that for the purposes of this specification, the term “ticket” will be understood to mean any document which serves to facilitate entry to an event, activity or mode of transport by a purchaser of the document, and to any document which is received as a result of placing a bet on the outcome of an event.

Admittance tickets for admitting a spectator to an event such as a sporting event or a musical event are widely used.

Purchasers of such tickets generally obtain the tickets from a ticket vending machine or from a booking office either in person or by telephone. In recent times, it has also been possible to purchase admittance tickets for an event via the Internet.

However, such conventional tickets have minimal marketing value to the ticket provider since the tickets are useable only to gain entry to a particular event and, other than any enjoyment the purchaser may obtain as a result of attending the event, do not provide any subsequent incentive for the purchaser of the ticket to purchase further tickets for subsequent events.

A similar situation arises with betting in that although a punter placing a bet on an outcome of an event has an opportunity to receive a financial gain if the selected outcome occurs, receiving the financial gain does not provide any subsequent incentive for the punter to place a bet on particular subsequent events related to the original event.

Furthermore, for purchasers of tickets for use in gaining access to a mode of transport such as an aeroplane, a train or a bus, there is little incentive, other than any perceived enjoyment or appreciation of service standard, for the purchaser of the ticket to purchase further tickets for subsequent journeys from a particular transport provider.

Conventional tickets generally take the form of rectangular shaped paper or cardboard material on which are printed details of the relevant event, such as information identifying the event, and the date, time and location of the event.

For memorabilia purposes, articles associated with a particular event are often collected and saved by spectators, collectors or other enthusiasts and it is not uncommon for such memorabilia to have significant monetary value which may increase with time.

To date, only modest interest exists in collecting event admittance tickets since the tickets have only limited visual appeal and as such have not been particularly desirable as souvenirs for collectors.

Furthermore, due to the simplicity of conventional tickets, it has been relatively easy to reproduce the tickets without authorisation, and it is not uncommon for many counterfeit tickets to be produced which are offered for sale to unsuspecting purchasers.

### SUMMARY OF THE INVENTION

In accordance with a first aspect of the present invention, there is provided a method of encouraging repeat ticket purchase, said method including the steps of:
providing a plurality of purchasable tickets associated with an event;
providing each of at least some of said tickets with a unique identifier;
randomly selecting at least one of said tickets provided with respective unique identifiers; and
offering to a ticket purchaser in possession of a randomly selected ticket an item associated with the event or an item associated with one or more participants in the event.

In this way, an event attendee is provided with an opportunity of receiving an item of potential memorabilia value which may increase in value over time, the opportunity of receiving the item serving as encouragement for a purchaser of a ticket to subsequently purchase a ticket associated with a future event

In one embodiment, the ticket is usable to gain access to an event.

In an alternative embodiment, the ticket is a betting receipt provided to a person on placing a bet on an outcome of an event.

The event may be a sporting event such as a basketball game or a cricket match. As an alternative, the event may be a musical or theatrical event, a motion picture, a horse racing event, a circus performance, or any other event wherein participants carry out activities and people are desirous of viewing or listening to the activity.

For a sporting event, a participant may be a basketball player, a golfer, a soccer player, and so on. For a musical or theatrical event, a participant may be a musician, an actor or a comedian. It is envisaged that in a further alternative, a participant may be an animal taking part in an event such as a circus show.

In one arrangement, the item is a garment worn by a participant in the event.

In an alternative arrangement, the item is an article used by a participant in the event.

The step of allocating tickets for the event may include the steps of allocating first tickets identifiable as tickets useable to gain access to the event, said first tickets not being available for random selection, and allocating second tickets identifiable as tickets useable to gain access to the event, said second tickets being available for random selection.

Preferably, the second tickets comprise a substrate and printed matter disposed on the substrate, the printed matter having characteristics related to at least one event participant.

The purchase price of the second tickets may be greater than the purchase price of the first tickets.

In one arrangement, the step of allocating tickets for an event includes the steps of allocating first tickets identifiable as tickets wherein a portion of the ticket is not to be torn off by an event representative, and allocating second tickets identifiable as tickets wherein a portion of the ticket is to be torn off by an event representative. The first tickets may be for use by a user to gain access to an event having at least one associated event participant and each first ticket may comprise a substrate and printed matter disposed on the substrate, the printed matter having characteristics related to at least one event participant.

The unique identifier may be a ticket number.

In accordance with a second aspect of the present invention, there is provided a ticket for use by a user to gain access to an event, the event having at least one associated event participant, the ticket comprising:
a substrate; and
printed matter disposed on the substrate, the printed matter having characteristics related to the at least one event participant.

The event may be a sporting event such as a basketball game or a cricket match. As an alternative, the event may be a musical or theatrical event, a motion picture, a horse racing event, a circus performance, or any other event wherein participants carry out activities and people are desirous of viewing or listening to the activity.

For a sporting event, a participant may be a basketball player, a golfer, a soccer player, and so on. For a musical or theatrical event, a participant may be a musician, an actor or a comedian. It is envisaged that in a further alternative, a participant may be an animal taking part in an event such as a circus show.

In one arrangement, the printed matter has characteristics related to one participant.

In an alternative arrangement, the printed matter has characteristics related to a plurality of participants.

In an alternative arrangement, the printed matter has characteristics related to a first participant associated with a first participant team and characteristics related to a second participant associated with a second participant team.

In a further alternative arrangement, the printed matter has characteristics related to one participant team.

In a further alternative arrangement, the printed matter has characteristics related to a plurality of participant teams.

A participant team may be a collective of participants forming, for example, a basketball team, but may as an alternative be a team of animals performing for example at a circus event, or a collection of race horses taking part in a racing event.

The substrate may be formed of paper, cardboard, plastic or metal material as convenient. A rigid or semi-rigid substrate material is preferred in order that the shape of the ticket may be maintained, in particular if the ticket is to be retained as a souvenir for memorabilia purposes after the event.

Preferably, the substrate is of a form which can conveniently be held in a hand of a purchaser. The substrate may be of generally planar rectangular configuration and of a convenient shape and size to be held in a hand. For example, a planar substrate with dimensions of approximately 14.5 cm by 6.5 cm is considered to be a convenient shape and size.

The substrate is preferably provided with a front face and a rear face. The printed matter may be disposed on one or more of the front and rear faces.

In one arrangement, a front face of the ticket may be provided with printed matter having characteristics related to at least one first event participant, and a rear face of the ticket may be provided with printed matter having characteristics related to at least one second event participant. The first event participant may be a member of a first event participant team and the second participant may be a member of a second event participant team. Alternatively, the printed matter provided on the front face may include characteristics related to a first team of participants and the printed matter provided on the rear face of the ticket may include characteristics related to a second team of participants.

The printed matter may take a variety of forms and may be printed directly onto the substrate surface or may be printed onto a surface layer and the surface layer bonded to the substrate surface in any suitable way.

It is envisaged that the printed matter may include textual and/or graphical information such as the names, numbers, statistics and graphical representations of the participants.

In a preferred embodiment, the printed matter includes a photograph of a participant, photographs of a number of participants, or a photograph of a team of participants, depending on whether one participant, a number of participants or a whole team of participants is to be represented on the ticket.

The printed matter may also include other information such as photographs and/or details of coaches and/or managers associated with a particular participant or with the participant team. Furthermore, the printed matter may also include a team trademark, team colours and/or information which identifies team sponsors.

It is also envisaged that the printed matter may change to include varying colours, symbols, or patterns, either for aesthetic purposes or for a symbolic reason, for example to symbolise a home or away game.

It is also within the scope of the invention that the printed matter may include a holographic portion or may be at least partially embossed.

Preferably, the ticket is provided with a “watermark” or other characterising mark so as to reduce the possibility of counterfeiting.

Other printed matter not related to an event participant may also be included on the ticket, such as information indicative of the date, time and location of the event, the entry price, the relevant seat number, a trade mark of the organisation administering ticket issue, and so on.

Preferably, a blank region is provided on the ticket for receiving an autograph of a participant.

Tickets according to the invention may include identifiers arranged to facilitate identification of the tickets by, for example, a computing system.

In one arrangement, the ticket includes a plurality of substrate portions. The ticket may be arranged such that at least some of the substrate portions are capable of separation. In order to facilitate separation of the substrate portions, the ticket may be provided with perforations. Preferably, the perforations are arranged such that printed matter which has potential value for memorabilia purposes is disposed in one or more first substrate portions and printed matter not of potential memorabilia value but of use to event organisers is disposed in one or more second substrate portions, the first and second substrate portions being separable on entry into an event by tearing along the perforations.

In accordance with a third aspect of the present invention, there is provided a method of producing a ticket for use by a user to gain access to an event, the event having at least one associated event participant, the method comprising the steps of:
providing a substrate; and
disposing printed matter on the substrate, the printed matter having characteristics related to the at least one event participant.

In accordance with a fourth aspect of the present invention, there is provided a method of encouraging repeat ticket purchase, said method including the steps of:
providing a plurality of tickets usable to gain access to a mode of transport;
providing each of at least some of said tickets with a unique identifier;
randomly selecting at least one of said tickets provided with respective unique identifiers; and
offering an item to a ticket purchaser in possession of a randomly selected ticket.

In one arrangement, the item is provided by an organisation sponsored by the transport provider. The item may be associated with a sporting event, a musical event or a theatrical event.

### BRIEF DESCRIPTION OF THE DRAWINGS

The present invention will now be described, by way of example only, with reference to the accompanying drawings, in which:

FIG. 1 is a diagrammatic front plan view of a ticket in accordance with an embodiment of the present invention;

FIG. 2 is a diagrammatic front plan view of the ticket shown in FIG. 1 with additional event details;

FIG. 3 is an enlarged view of a portion of the ticket shown in FIG. 1;

FIG. 4 is a diagrammatic front plan view of a ticket in accordance with an alternative embodiment of the present invention;

FIG. 5 is a diagrammatic front plan view of a ticket in accordance with a further alternative embodiment of the present invention;

FIG. 6 is a diagrammatic front plan view of a ticket in accordance with a further alternative embodiment of the present invention;

FIG. 7 is a diagrammatic rear plan view of the ticket shown in FIG. 6;

FIG. 8 is a diagrammatic front plan view of a ticket in accordance with a further alternative embodiment of the present invention;

FIG. 9 is a diagrammatic front plan view of a ticket in accordance with a further alternative embodiment of the present invention;

FIG. 10 is a flow diagram of a method of encouraging repeat ticket purchase in accordance with an embodiment of the present invention; and

FIG. 11 is a flow diagram illustrating a method of encouraging repeat ticket purchase in accordance with an alternative embodiment of the present invention.

### DESCRIPTION OF AN EMBODIMENT OF THE PRESENT INVENTION

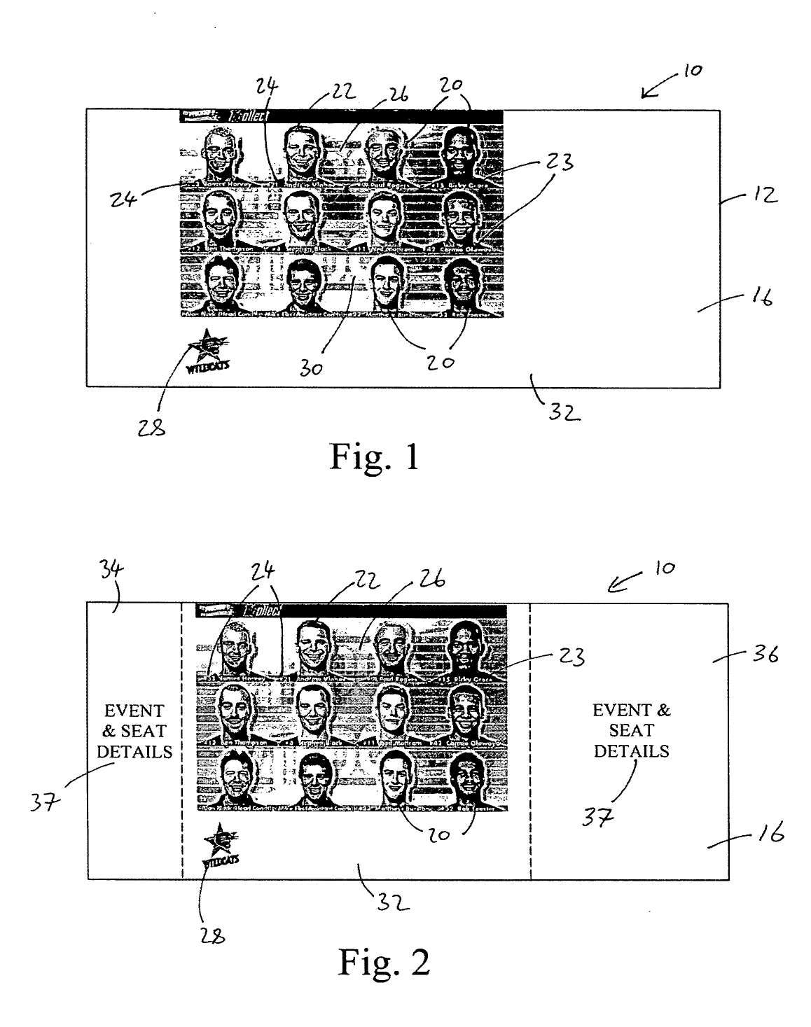

Referring to FIGS. 1 to 9 of the drawings, there is shown a ticket 10 in accordance with an embodiment of the present invention. The ticket 10 comprises a substrate 12 which in this example has a planar rectangular configuration. Disposed on the substrate 12 is printed matter of various forms.

In some embodiments, the ticket 10 also includes perforations 14 which facilitate easy separation of adjacent substrate portions of the ticket 10.

As will be seen in the embodiments shown in FIGS. 1 to 3, printed matter in various forms is arranged on a front face 16 of the ticket 10.

In this particular embodiment, twelve photographs 20 arranged in three rows of four photographs are printed on the front face 16 of the ticket 10. The twelve photographs show a team of ten players associated with a predetermined event, in this example a basketball game, together with photographs of the head coach and assistant coach of the basketball team. For example, a photograph showing the head and shoulders of basketball player Andrew Vlahov is shown at 22. In this example, the name 23 and team number 24 of the players are also provided on the ticket 10.

It will be understood that by providing a ticket 10 with photographs 20 of all team players and of the team coaches, an attendee at a particular event is able to obtain a historical record of the team players and coaches for a particular event or a particular season of events.

It will also be understood that by disposing printed matter on the ticket 10 in this way, it is possible to provide an attendee with a different ticket for each event associated with a team. For example, tickets may be produced which include a photograph of one team player with the identity of the team player changing for each event. In this way, an attendee is able to collect tickets with photographs representing all team players by attending each event in a season. However, other arrangements are also possible, including providing the same ticket for all events associated with a particular team during a season.

As can be seen in FIGS. 1 to 3, additional printed matter is also disposed on the ticket 10 including a striped background 26 visible behind the photographs 20, and a team trademark 28.

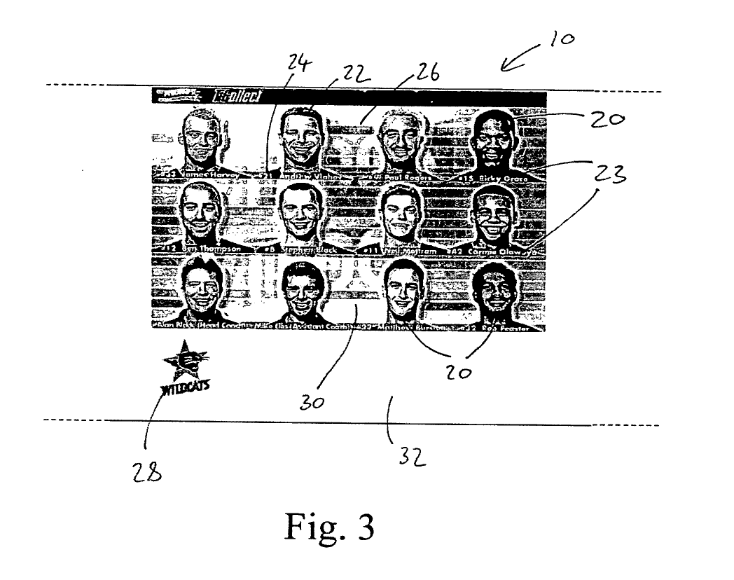

Furthermore, additional printed matter may be added such as a “watermark” feature which serves to reduce the likelihood of ticket counterfeiting. As can best be seen in FIG. 3, in this embodiment, a “watermark” feature 30 is visible behind the photographs 20, the “watermark” feature 30 in this example being the team name “WILDCATS”.

As can be noted in FIGS. 1 to 3, a blank region 32 is provided for receiving an autograph of a participant in the event.

In FIG. 2, first and second perforations 14a, 14b define first and second tear-off portions 34 and 36 respectively, each of the tear-off portion 34, 36 including additional printed matter such as event and seat details 37. It is envisaged that the ticket 10 may be torn along the first perforation 14a so as to separate the first tear-off portion 34 from the remainder of the ticket 10. The first tear-off portion 34 could be separated on entry into an event in order that the spectator may retain the remainder of the ticket 10 which includes the photographs 20 of the team and coaches. In this way, the remainder of the ticket 10 may serve as a record of the team players for an event and therefore an item of potential memorabilia value.

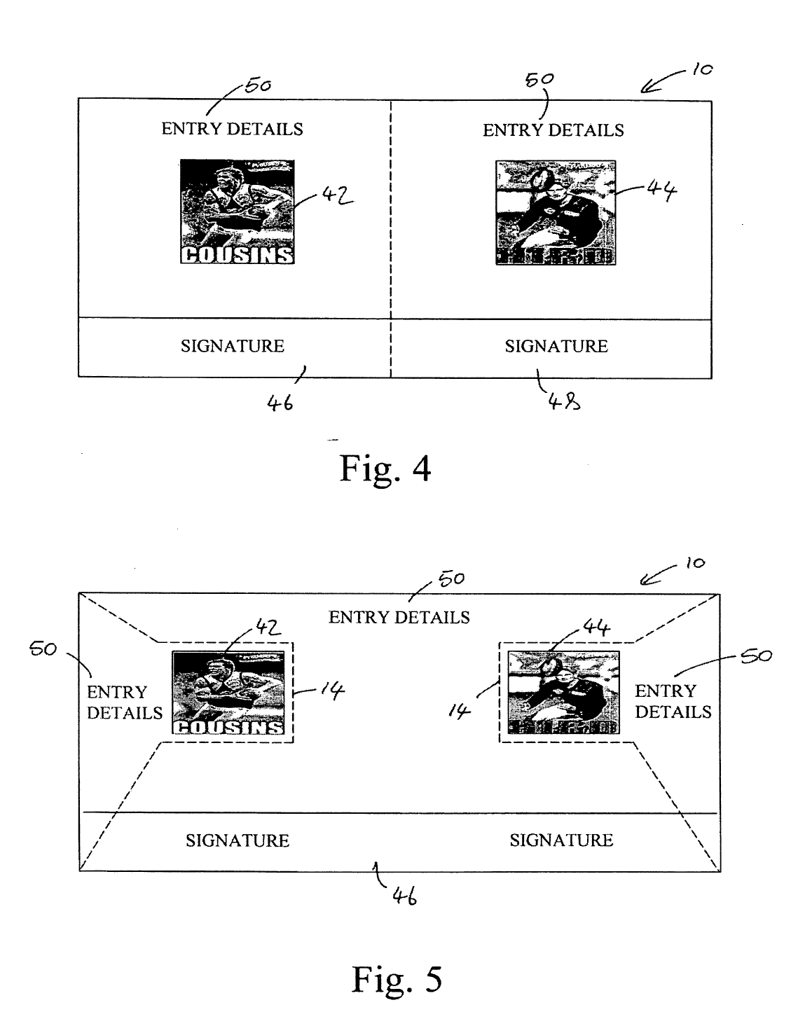

Alternative embodiments of a ticket in accordance with the present invention are shown in FIGS. 4 to 9.

FIG. 4 shows an alternative ticket 10 which includes a photograph 42, 44 of one player from each of the competing teams. Each ticket 10 is further provided with blank regions 46, 48 for receiving autographs of the two players represented on the ticket 10. Entry and event details 50 are also included on the ticket 10.

FIG. 5 shows a further alternative ticket 10 which is similar to the embodiment shown in FIG. 4 in that the ticket 10 includes a photograph 42, 44 of one player from each of the competing teams together with entry and event details 50 and a region 46 for receiving photographs. However, the relative positions of the photographs 42, 44, blank regions 46, 48 and entry and event details 50 in the embodiments shown in FIGS. 4 and 5 are different.

Each of the tickets shown in FIGS. 4 and 5 also includes perforations 14 to facilitate separation of portions of the ticket from each other.

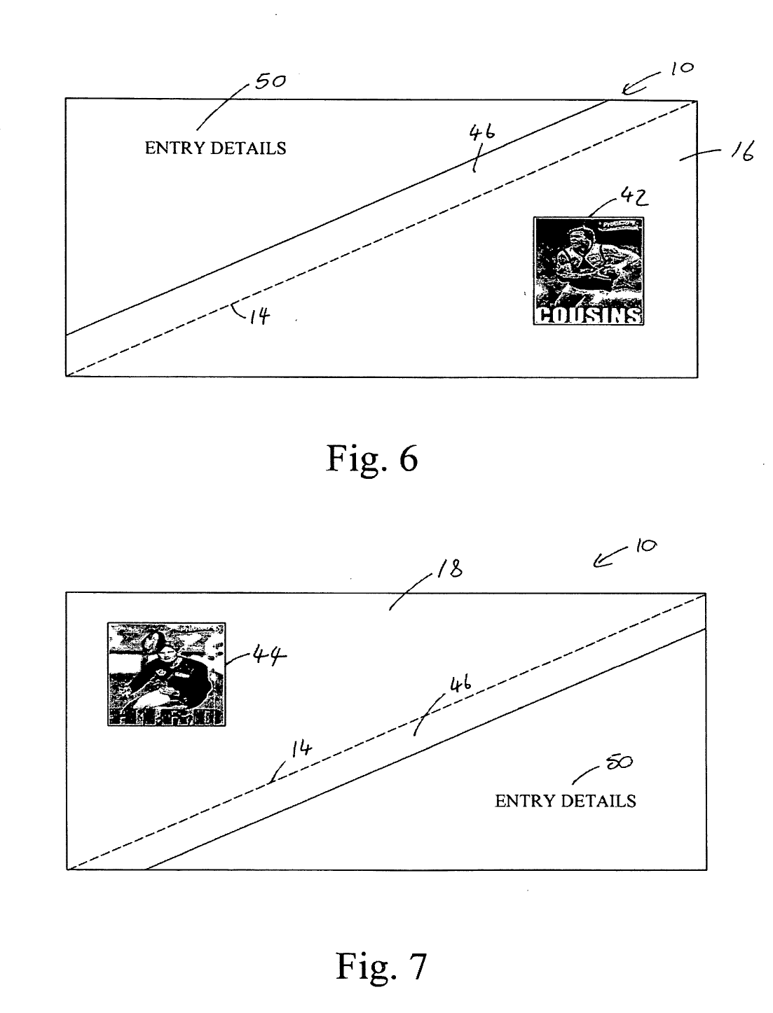

In FIGS. 6 and 7, a further alternative embodiment is shown which is similar to the embodiments shown in FIGS. 4 and 5. Like features are indicated with like reference numerals. The ticket 10 includes printed matter 42 relating to a first player, in this example a photograph of player Ben Cousins, disposed on the front face 16 of the ticket, as shown in FIG. 6, and printed matter 44 relating to a second player, in this example a photograph of player James Hird, disposed on the rear face 18 of the ticket 10, as shown in FIG. 7.

It will therefore be understood that both the front and rear faces 16, 18 of the ticket 10 may include printed matter and that, in particular in the case of two competing teams, printed matter relating to a first team or a player of the first team may be disposed on the front face 16 of the ticket, and printed matter relating to a second team or a player of the second team may be disposed on the rear face 18 of the ticket.

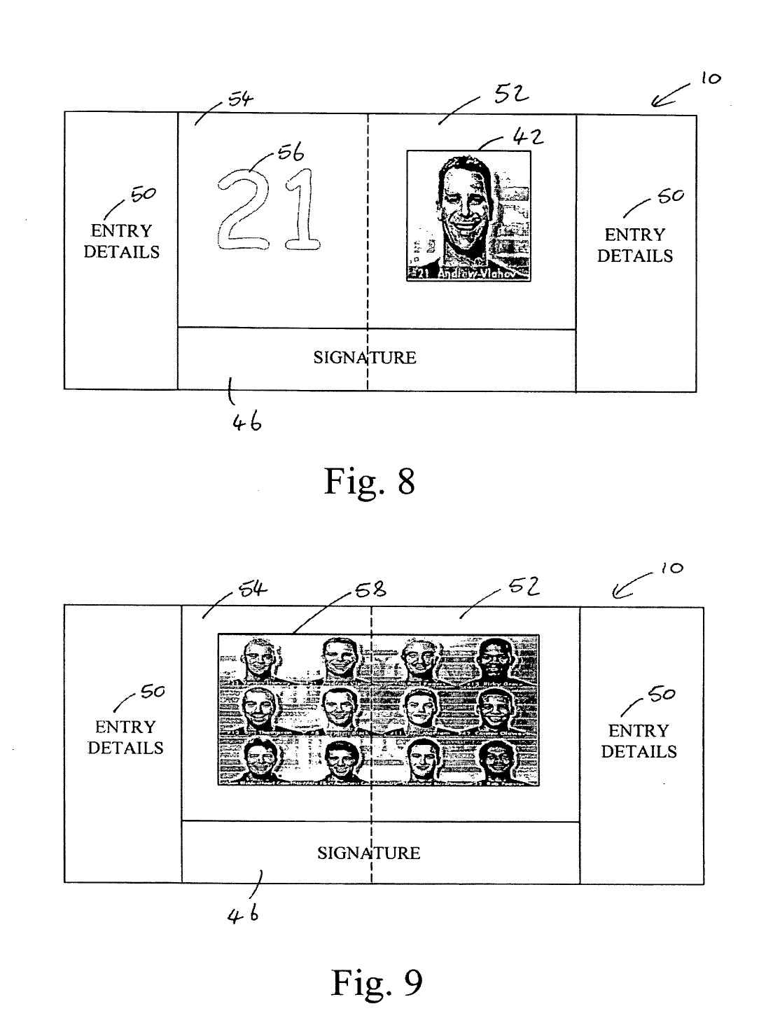

Further alternative embodiments of tickets in accordance with the present invention are shown in FIGS. 8 and 9. Like features are indicated with like reference numerals. In particular, it can be seen in FIG. 8 that a ticket 10 including printed matter relating to a single player may be disposed on the ticket 10, with a graphical representation 42 of the player being disposed on a first portion 52 of the ticket, and other details relating to the player being disposed on a second portion 54 of the ticket, such as the team number associated with the player. The embodiment shown in FIG. 9 is similar to the embodiment shown in FIG. 8, except that printed matter relating to a single team is disposed on the ticket 10 with a graphical representation 58 of the team being disposed on first and second portions 52, 54 of the ticket 10.

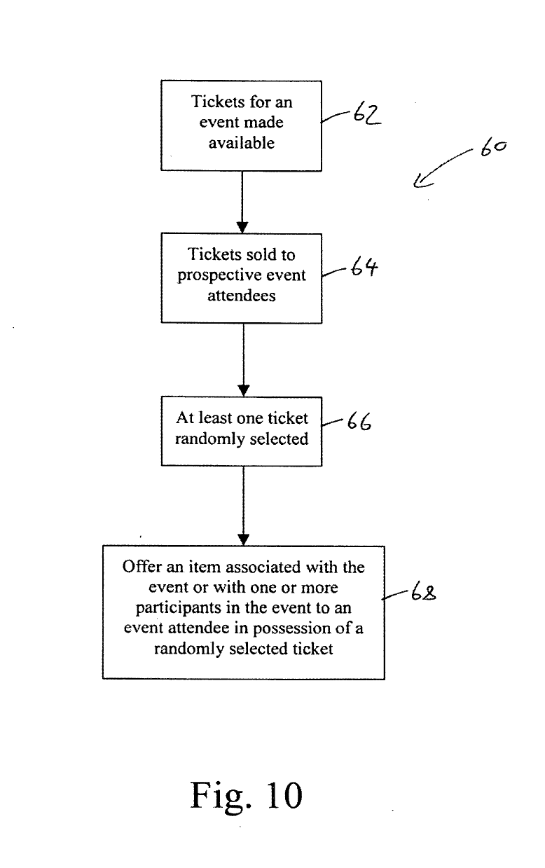

Referring to FIG. 10, there is shown a flow diagram 60 illustrating an embodiment of a method of encouraging repeat ticket purchase in accordance with the present invention.

As indicated by steps 62, 64, 66 and 68 of the flow diagram 60, a predetermined number of tickets for an event are made available by organisers of the event. The tickets may take various forms and may include at least some tickets corresponding to the tickets described above in relation to FIGS. 1 to 9, although this is not necessarily the case.

Prior to and optionally during an event the available tickets are sold to prospective event attendees either at the event venue or elsewhere. Each ticket is unique and identifiable, for example by including on each ticket a unique identifier which may or may not be visible to the eye. In one example, the unique identifier is a ticket number. By purchasing a ticket, a user is automatically entered into a draw wherein at least one ticket is chosen by randomly selecting an identifier associated with a ticket, the event attendee in possession of the randomly selected ticket receiving an item associated with the event or associated with one or more participants in the event.

It will be understood that a ticket may be chosen in any suitable way. For example, a ticket may be chosen by storing all identifiers associated with sold tickets on a computer and programming the computer so as to randomly select one of the identifiers. Alternatively, a ticket may be chosen by collecting tom-off portions of sold tickets and retrieving one of the torn-off portions. Of course, with this alternative arrangement, both the torn-off portion and the remainder of the ticket must include the unique identifier.

It will be understood that the item may take various forms, such as an item of clothing worn by a participant in the event, an article used by a participant in the event, such as a guitar or a soccer ball, and so on.

It will also be understood that variations to the arrangement shown in FIG. 10 within the scope of the present invention are envisaged. For example, instead of providing all attendees with an opportunity to receive an item associated with the event or with one or more participants in the event, the method may be arranged so that first and second ticket types are made available for purchase, the first type of tickets serving only to gain access to the event and the second type of tickets serving to both gain access to the event and to provide attendees with an opportunity to receive an item associated with the event or with one or more participants in the event. The first and second types of tickets may be distinguished from each other in any suitable way. For example, the first type of ticket may be a conventional ticket and the second type of ticket may be of a type described above in relation to FIGS. 1 to 9.

Second type tickets which are not sold prior to an event may be made available for subsequent purchase as memorabilia items.

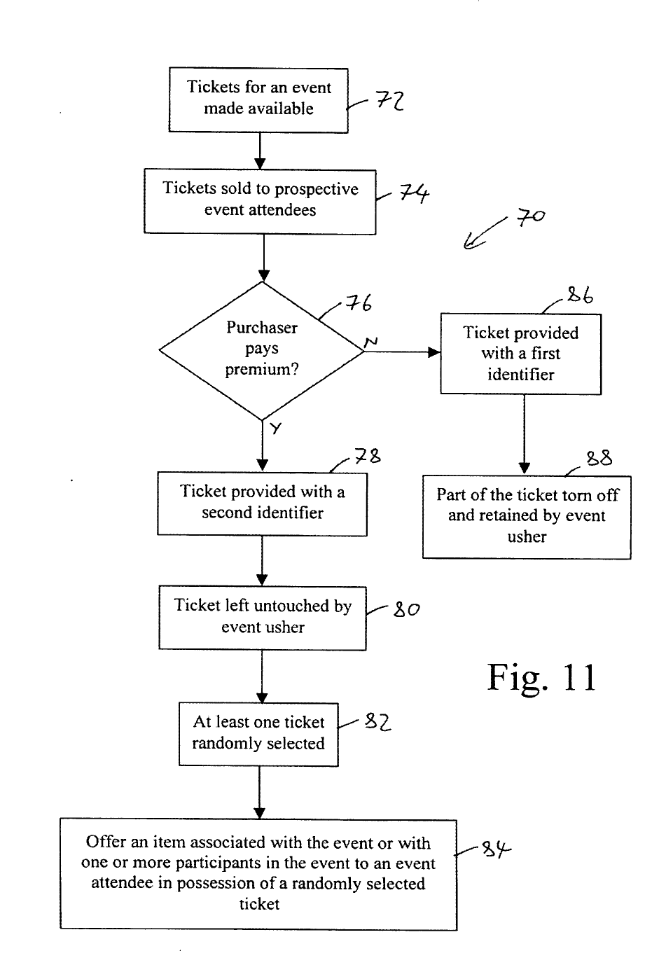

Referring to the flow diagram 70 shown in FIG. 11, a further variation of the method shown in FIG. 10 is illustrated with reference to steps 72 to 88.

With this variation, two types of tickets are made available for purchase by prospective event attendees. As with the above described variation, a first type of ticket serves only to allow access to an event and a second type of ticket serves to both allow access to an event and to provide an opportunity to receive an item associated with the event or an item associated with one or more participants in the event.

If the purchaser elects to buy a first type ticket, the ticket is provided with a first identifier which is interpreted by an event usher as an instruction to tear off a portion of the ticket. In this example, the first type tickets are conventional tickets and, as such, do not include printed matter having characteristics related to the at least one event participant.

If a purchaser opts to buy a second type ticket, the ticket is provided with a second identifier which is interpreted by an event usher as an instruction to not tear off any portions of the ticket and allow the attendee to retain the ticket intact.

It will be understood that since the second type ticket remains intact, the ticket is likely to have a value as a collectable item which is greater than would have been the case if a portion of the ticket had been torn off. An attendee in possession of a second type ticket also gains an opportunity to receive an item associated with the event or with one or more participants in the event.

It will be understood that, in practice, the cost of purchasing a second type ticket would be greater than the cost of purchasing a first type ticket.

It will also be understood that although a ticket may be usable to gain access to an event, there is no requirement for a purchaser of such a ticket to actually attend the event, and as an alternative a ticket may be purchased with the intention only of providing an opportunity to receive an item associated with the event.

Furthermore, it will be understood that although the above embodiments have been described in relation to a ticket of the type for use in accessing an event, other types of ticket are envisaged. For example, the ticket may be a betting receipt provided to a person on placing a bet on an outcome of an event. With this arrangement, a purchaser of a ticket would have an opportunity of receiving an item associated with the event or with one or more participants in the event in addition to an opportunity of receiving financial gain if the selected outcome occurs. The ticket may also be a ticket for use in gaining access to a mode of transport, such as an aeroplane, train or bus. With this arrangement, a purchaser of a ticket would have an opportunity of receiving an item merely by purchasing a ticket for a desired journey. The item may be provided by an organisation sponsored by the transport provider and the sponsored organisation may be associated with sporting, musical or theatrical events. The item may be associated with such an event or with a participant in such an event.

Throughout the specification, unless the context requires otherwise, the word “comprise” or variations such as “comprises” or “comprising”, will be understood to imply the inclusion of a stated integer or group of integers but not the exclusion of any other integer or group of integers.

Modifications and variations as would be apparent to a skilled addressee are deemed to be within the scope of the present invention.

1. A method of encouraging repeat ticket purchase, said method including the steps of:
providing a plurality of purchasable tickets associated with an event;
providing each of at least some of said tickets with a unique identifier;
randomly selecting at least one of said tickets provided with respective unique identifiers; and
offering to a ticket purchaser in possession of a randomly selected ticket an item associated with the event or an item associated with one or more participants in the event.

2 A method as claimed in claim 1, wherein the ticket is usable to gain access to an event.

3. A method as claimed in claim 1, wherein the item is a garment worn by a participant in the event.

4. A method as claimed in claim 1, wherein the item is an article used by a participant in the event.

5. A method as claimed in claim 1, wherein the step of providing tickets for the event includes the steps of allocating first tickets identifiable as tickets usable to gain access to the event, said first tickets not being available for random selection, and allocating second tickets identifiable as tickets usable to gain access to the event, said second tickets being available for random selection.

6. A method as claimed in claim 5, wherein the first tickets comprise:
a substrate; and
printed matter disposed on the substrate, the printed matter having characteristics related to at least one of the event participants.

7. A method as claimed in claim 6, wherein the purchase price of the second tickets is greater than the purchase price of the first tickets.

8. A method as claimed in claim 1, wherein the step of allocating tickets for an event includes the steps of allocating first tickets identifiable as tickets wherein a portion of the ticket is not to be torn off by an event representative, and allocating second tickets identifiable as tickets wherein a portion of the ticket is to be torn off by an event representative.

9. A method as claimed in claim 8, wherein the first tickets are for use by a user to gain access to an event having at least one associated event participant, each first ticket comprising:
a substrate; and
printed matter disposed on the substrate, the printed matter having characteristics related to the at least one event participant.

10. A method as claimed in claim 1, wherein the ticket is a betting receipt provided to a person on placing a bet on an outcome of the event.

11. A ticket for use by a user to gain access to an event, the event having at least one associated event participant, the ticket comprising:
a substrate; and
printed matter disposed on the substrate, the printed matter having characteristics related to the at least one event participant.

12. A ticket as claimed in claim 11, wherein the event is a sporting event and the at least one event participant is at least one player.

13. A ticket as claimed in claim 11, wherein the event is a musical or theatrical event and the at least one event participant is at least one musician, actor or comedian.

14. A ticket as claimed in claim 11, wherein the printed matter has characteristics related to one participant.

15. A ticket as claimed in claim 11, wherein the printed matter has characteristics related to a plurality of participants.

16. A ticket as claimed in claim 15, wherein the printed matter has characteristics related to a first participant associated with a first participant team and characteristics related to a second participant associated with a second participant team.

17. A ticket as claimed in claim 11, wherein the printed matter has characteristics related to one participant team.

18. A ticket as claimed in claim 17, wherein the printed matter has characteristics related to a plurality of participant teams.

19. A ticket as claimed in claim 11, wherein the substrate has a front face and a rear face and the printed matter is disposed on the front and rear faces.

20. A ticket as claimed in claim 19, wherein a front face of the ticket is provided with printed matter having characteristics related to at least one first event participant, and a rear face of the ticket is provided with printed matter having characteristics related to at least one second event participant.

21. A ticket as claimed in claim 20, wherein the first event participant is a member of a first event participant team and the second participant is a member of a second event participant team.

22. A ticket as claimed in claim 21, wherein the printed matter provided on the front face has characteristics related to a first team of participants and the printed matter provided on the rear face has characteristics related to a second team of participants.

23. A ticket as claimed in claim 11, wherein the printed matter is printed directly onto the substrate.

24. A ticket as claimed in claim 11, wherein the printed matter is printed onto a surface layer, the surface layer being bonded to the substrate.

25. A ticket as claimed in claim 11, wherein the printed matter includes textual information related to the at least one event participant.

26. A ticket as claimed in claim 25, wherein the textual information includes the name, team number and/or statistics related to the at least one event participant.

27. A ticket as claimed in claim 11, wherein the printed matter includes graphical information related to the at least one event participant.

28. A ticket as claimed in claim 27, wherein the printed matter includes a photograph of the at least one event participant.

29. A ticket as claimed in claim 11, further including a blank region for receiving an autograph of a participant.

30. A ticket as claimed in claim 11, further including a plurality of separable substrate portions arranged such that printed matter which has potential value for memorabilia purposes is disposed in one or more first substrate portions and printed matter not of potential memorabilia value but of use to event organisers is disposed in one or more second substrate portions, the first and second substrate portions being separable from each other.

31. A method of producing a ticket for use by a user to gain access to an event, the event having at least one associated event participant, the method comprising the steps of:
providing a substrate; and
disposing printed matter on the substrate, the printed matter having characteristics related to the at least one event participant.

32. A method of encouraging repeat ticket purchase, said method including the steps of:
providing a plurality of tickets usable to gain access to a mode of transport;
providing each of at least some of said tickets with a unique identifier;
randomly selecting at least one of said tickets provided with respective unique identifiers; and
offering an item to a ticket purchaser in possession of a randomly selected ticket.

33. A method as claimed in claim 32, wherein the item is provided by an organisation sponsored by the transport provider.

34. A method as claimed in claim 32, wherein item is associated with a sporting event, a musical event or a theatrical event.
